(19) United States
(12) Patent Application Publication
(10) Pub. No.: US 2006/0213994 A1
(43) Pub. Date: Sep. 28, 2006

(54) Barcode reading apparatus and method therefor

(76) Inventors: Tariq Nadeem Faiz, Hockessin, DE (US); Javed Ameer, Newark, DE (US)

Correspondence Address: AGILENT TECHNOLOGIES, INC.;Legal Department, DL429, Intellectual Property Administration, P. O. Box 7599, Loveland, CO, 80537-0599, US

(21) Appl. No.: 11/086,029

(22) Filed: Mar. 22, 2005

(51) Int. Cl. G06K 7/10

(52) U.S. Cl. 235/462.05

(57) ABSTRACT

A barcode reading apparatus for reading a translucent barcode label or strip that has opaque indicia such as spaced black bars on a translucent background. The barcode reading apparatus includes a transmitter for projecting an incident light beam toward the label so that some of the light is returned back from the translucent background and some of the light passes through the translucent background to a light returning surface on the opposite side of the slide. The portion of the incident light beam that strikes the light returning surface is returned back through the slide toward a detector portion of the barcode reader. This portion of returned light produces a signal that is added to the signal produced by the portion of the incident light beam initially returned from the translucent background of the barcode label to produce a much stronger identifying signal.

### CROSS-REFERENCE TO RELATED APPLICATIONS

NOT APPLICABLE

### BACKGROUND OF THE INVENTION

The present invention relates generally to a scanning mechanism and, more specifically, to a barcode reading mechanism for a DNA Microarray Scanner that identifies and quantifies genetic material.

A microarray scanner includes a carousel that has radial slots. The carousel is rotatably mounted on a support that includes an annular wall surrounding the carousel. The annular wall has an access opening to the carousel. Each radial slot is adapted to receive a holder containing a transparent slide, e.g. a 1″ by 3″ glass slide. Each slide is located in a custom slide holder. A biological sample to be examined is located on one side of the slide. The sample is DNA or RNA material extracted from a biological sample. In a process known as Hybridization, the sample is allowed to bond with known DNA sequences or probes deposited in a two-dimensional array on the glass slide. A barcode that identifies the specimen to be examined is located on one side of the slide and spaced from the sample. The barcode is used to identify the sample on the slide in all phases of its processing, including hybridization, scanning and software analysis. A slide examination or scanning station is located outside of the carousel. An instrument at the slide examination station scans and produces a high-resolution image file of the array. A barcode reading mechanism is located between the examination station and the carousel just outside the access opening.

During operation of the scanner, the carousel is selectively rotated so as to position a selected holder and contained slide at the access opening. A transfer mechanism grasps the selected holder and carries it through the barcode reading station to the slide examination station. The transfer mechanism is a robotic arm-like assembly used to transport the slide holder and slide out of the carousel before scanning, and back into the carousel after scanning. As the holder and the slide move through the barcode reading station, the barcode reader reads the barcode on the slide. The barcode on the slide is in the form of a label or strip that is applied to one of the surfaces of the slide. In the past, biological scanning mechanisms were set up so that a probe array containing a biological specimen was located on one side of the slide and a conventional barcode label or strip was located on the opposite side of the slide. A conventional barcode label or strip has black spaced bars on a white reflective background. The barcode label was read by a barcode reader located at the barcode reading station on the side of the station facing the side of the slide containing the barcode.

For many sample scanning procedures, the barcode is required to be placed on the same side of the glass slide as the biological specimen sample or the “array” side of the slide. Since the barcode reader is located on the opposite side of the “array” side of the slide, a conventional barcode label cannot be read. In order to accommodate the above-described sample scanning procedures, a translucent barcode label was used. The translucent barcode label has black bars on a translucent background. An incident light beam from the barcode reader is projected through the transparent slide to the barcode label. A portion of the light beam is returned back toward the barcode reader to enable the barcode to be read by the barcode reader. Light from the barcode reader can be infrared, laser, or any state of the art light source. Since the background of the barcode label is translucent, a portion of the incident light beam passes through the barcode label so that the portion of the light beam returned back to the barcode reader is not as strong as the incident light beam. Normally, a series of incident light beams are directed toward the barcode as the slide passes through the barcode reading station to obtain several identifying signals for averaging to provide a consensus signal. In many cases the signals are not strong enough to provide an accurate identification of the barcode being read. This problem becomes more acute if there is any degradation of the label during treatment of the slide during the steps in pre and post hybridization operation, i.e. washings.

The translucent barcode label must also be used in a microarray scanning mechanism in which the barcode reader is located on the “array” side of the slide but the barcode label is required to be placed on the opposite side of the slide. For example, the barcode label might need to be changed and applying it on the non-array side of the slide minimizes any contact with the array. Having the barcode label on the non-array side of the slide also minimizes any contact with wash chemicals during array processing.

What is generally needed is a barcode reading apparatus that is able to read translucent barcode labels with high accuracy.

### BRIEF SUMMARY OF THE INVENTION

In one aspect, the present invention provides a barcode reading apparatus for reading a translucent barcode label that has opaque indicia such as spaced black bars on a translucent background. The barcode reading apparatus includes a transmitter for projecting an incident light beam toward the label so that some of the light is returned back from the translucent background toward a detector portion of a barcode reader and some of the light passes through the translucent background to a light returning device on the opposite side of the slide, said light returning device bearing a light returning surface. The term “light returning device” is used herein to describe a device bearing a light returning surface. A light returning surface is a surface that is capable of receiving a beam of light from a source, and, in reaction to receiving the beam of light, radiates a return beam of light toward a light sensor associated with the source. The portion of the incident light beam that strikes the light returning surface is returned back through the slide toward the detector portion of the barcode reader. This portion of returned light produces a signal that is added to the signal produced by the portion of the incident light beam initially returned from the translucent background of the barcode label to produce a much stronger identifying signal.

### BRIEF DESCRIPTION OF THE DRAWINGS

The invention is described in the accompanying drawings in which:

FIG. 1 is a fragmentary plan view of a biological scanning mechanism illustrating the barcode reading apparatus according to one aspect of the present invention;

FIG. 2 is an isometric view of the light returning device portion of the barcode reading apparatus according to one aspect of the present invention;

FIG. 3 is an isometric view of the holder for the slide according to one aspect of the present invention;

FIG. 4 is a diagrammatic view showing the optical functions of the invention according to one aspect of the present invention; and

FIG. 5 is an isometric view of the slide showing the barcode and probe array according to one aspect of the present invention.

### DETAILED DESCRIPTION OF THE INVENTION

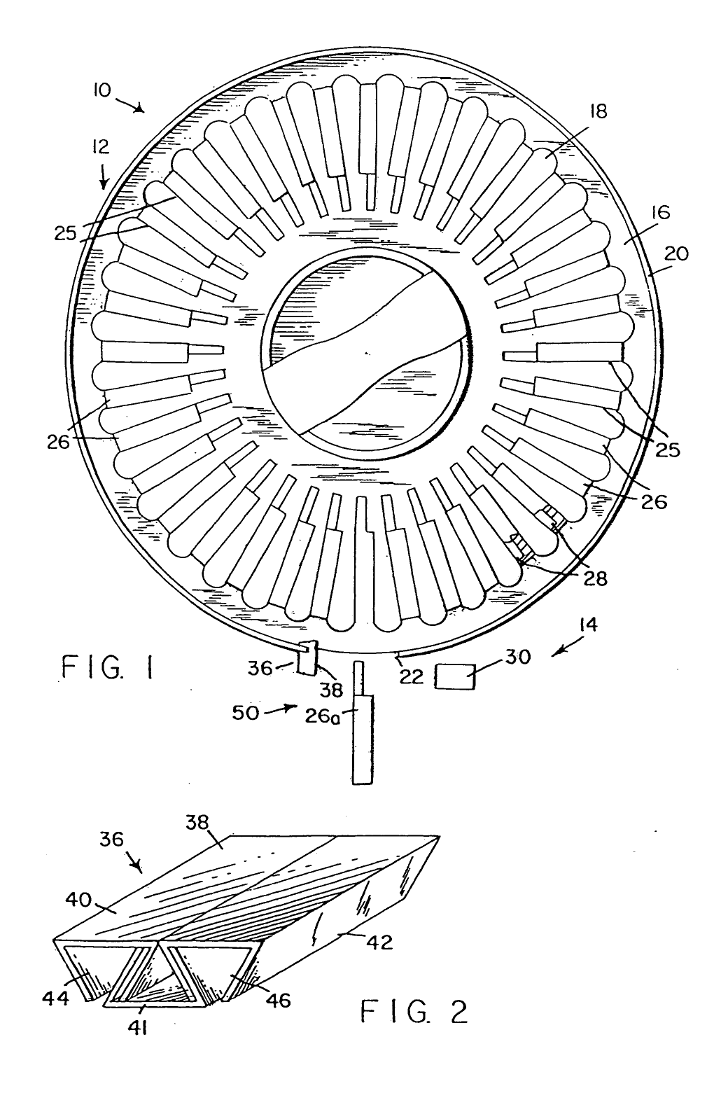

Referring to FIGS. 1 and 2, the scanning mechanism of the present invention is generally indicated by the reference numeral 10 and includes a slide carousel, generally indicated by the reference numeral 12, and a barcode reading apparatus, generally indicated by the reference numeral 14. The slide carousel 12 includes a fixed base 16 and a slide tray 18 rotatably mounted on the base 16. The base 16 has an annular outer wall 20 that includes a front opening 22. The tray 18 has slots 25 for holding a plurality of slide holders 26. Each slide holder 26 contains a slide 28.

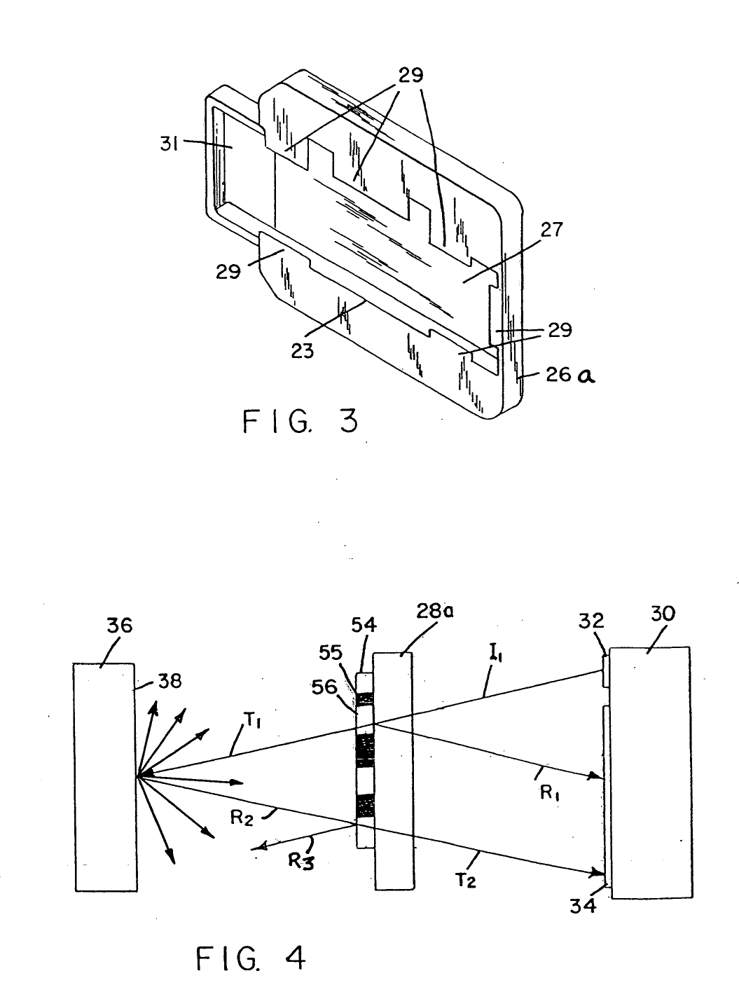

Referring to FIG. 3, one of the slide holders 26 is shown without its slide. Slide holder 26 defines a cavity 23 for receiving the slide. The slide is held in place by a side wall 27 and tabs 29. Side wall 27 can be pivoted to enable the slide to be inserted and then locked in place. Cavity 23 has a portion that extends beyond side wall 27 to form a window 31. The barcode label on the slide is positioned at the window 31 when the slide is in the holder.

Referring now to FIG. 1, the barcode reading apparatus 14 includes a barcode reader 30 and a light returning device, generally indicated by the reference numeral 36. The barcode reader 30 has a transmitter portion 32 for transmitting a beam of light and a receiver portion 34 for receiving a beam of light, see FIG. 4. In an embodiment, the barcode reader was a Keyence Corporation BL600HA laser barcode reader. However, other commercially-available barcode readers can also be used. The light returning device 36 has a flat light returning surface 38 and is mounted adjacent the front opening 22 with light returning surface 38 facing the barcode reader 30.

Referring particularly to FIG. 2, the light returning device 36 is a composite structure made from three white channel pieces 40, 41 and 42. Each channel piece has a flat base wall and a pair of side walls that extend away from the base wall at converging angles. The channel pieces 40 and 42 are arranged side by side with their bases in the same plane and forming the light returning surface 38. The piece 41 is arranged with its base spaced from and parallel to the bases of pieces 40 and 42 and its side walls extending toward the bases of pieces 40 and 42. The side walls of piece 41 straddle the adjacent side walls of pieces 40 and 41 and collectively form the inner side walls of the light returning device structure. The base of piece 40 engages the ends of the inner side walls of pieces 40 and 42. The pieces 40, 41 and 42 are fixed by plastic welding or glue, e.g. a Loctite™ instant adhesive. When the light returning device 36 is assembled as shown in FIG. 2, a pair of slots 44 and 46 is formed on opposite sides of the piece 41. Each slot 44 and 46 has an opening 48. Referring to FIG. 1, the light returning device 36 is mounted at the opening 22 by inserting the free end of the wall 20 that is furthest from the barcode reader 30 into one of the slots 44 and 46.

During operation of the scanning mechanism 10, the slide tray 18 is rotated until a selected holder and slide to be scanned and analyzed is aligned with the opening 22. The selected holder 26a containing the selected slide is grasped by a transfer mechanism, not shown, and removed from its respective slot 25. Slide holder 26a is transported through the barcode reading station, generally indicated by the reference numeral 50, to the specimen scanning apparatus, not shown.

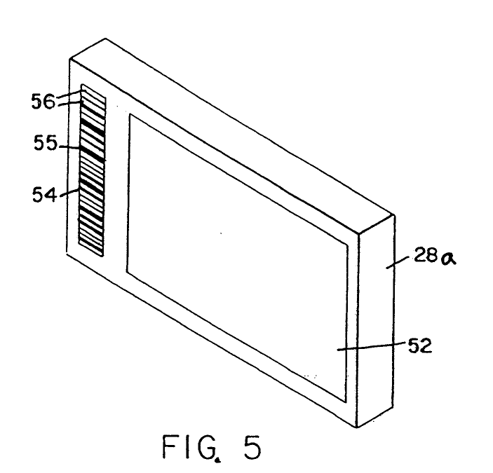

Referring to FIGS. 3-5, one of the slide holders 26a is shown in FIG. 3 without a slide. FIG. 4 is a schematic view looking toward the opening 22 of the carousel and showing a selected slide 28a as it passes between the light returning device 36 and the barcode reader 30. The holder containing the slide 28a is not shown for clarity of illustration. Slide 28a has a probe array 52 (as shown in FIG. 5) and a translucent barcode label 54 on the side of the slide that faces the light returning device 36. The portions of the barcode and probe array are shown in FIG. 5. The opposite side of the slide 28a faces the barcode reader 30. Barcode label 54 has opaque areas 55 and translucent areas 56.

As the holder 26a and slide 28a pass through the barcode reading station 50, between light returning device 36 and the barcode reader 30 as shown in FIG. 4, the barcode reader 30 transmits an incident light beam I₁, through the slide to the barcode label 54. Some of the light from the incident light beam I₁ is returned by the barcode label 54 toward the receiver portion of the barcode reader 30 as returned light R₁. The remainder of the incident light beam I₁ passes through the barcode label to the light returning surface 38 of light returning device 36 as transmitted beam T₁. Light returning surface 38 returns transmitted beam T₁ back toward the barcode label 54 as returned beam R₂. Some of the light from returned beam R₂ is returned by the barcode label 54 as returned beam R₃. The remaining portion of the returned beam R₂ is transmitted back to the barcode reader 30 as transmitted beam T₂. The barcode reader 30 transmits a sequence of incident light beams to the barcode label 54 as the slide 28a passes through the barcode reading station 50. The returned portions R₁ and T₂ of the incident light beam I₁ provide a print contrast signal. The print contrast signals from the several incident light beams I₁ are averaged by software associated with the barcode reader to produce a reading that identifies the barcode 54 and its associated probe array 52. The slide 28a, within its holder 26a, continues to be transported to the specimen scanning station and then returned to its respective slot 25 in the slide tray 18.

A performance feature of a barcode reader is its Print Contrast Signal. Print Contrast Signal=(Reflectance of Space−Reflectance of bar)/Reflectance of Space. Reflectance is used herein to describe light returning capacity by any mechanism, not just by formal reflection. The term “space” refers to the space between the bars in the bar code. Print Contrast Signal measures the contrast between light returned from the bars and light returned by the spaces on the barcode label. The following is a comparison of readings of a translucent barcode with and without a light returning device such as light returning device 36.

Without Light Returning Device
Reflectance of Space=R₁
With Light Returning Device
Reflectance of Space=R₁+T₂

Now T₂>0. Therefore it follows that:
Reflectance of Space with Light returning device>Reflectance of Space without Light returning device

Since the Reflectance of the bar is unchanged, it follows that:

Without Light Returning Device
Print Contrast Signal=1−Reflectance of Bar/Reflectance of Space=1−Reflectance of Bar/R₁
With Light Returning Device
Print Contrast Signal=−Reflectance of Bar/(R₁+T₂)
Since,
(R1+T2)/Reflectance of Bar>R1/Reflectance of Bar, it follows that their negative reciprocals are related as,
−Reflectance of Bar/(R1+T2)>−Reflectance of Bar/R1 and,
1−Reflectance of Bar/(R1+T2)>1−Reflectance of Bar/R1

Therefore, Print Contrast Signal (with light returning device)>Print Contrast Signal (without Light returning device). This assumes that the reflectance (light returning efficiency) of the light returning device is 100%. However, it can be shown that any significant amount of return light from the light returning device improves the Print Contrast Signal.

The present invention enables the translucent barcode label on the glass slide to be read by the barcode reader 3 with high efficiency. Barcode labels with barcodes printed on opaque white background or transparent background can also be used with the barcode reading apparatus of the present invention.

Some styles of barcodes with imperfections in their printing can also be read. For instance:
1. Barcodes printed close to the right or left edge might have smaller quiet zones than needed. By returning light transmitted through the barcode back to the reader, the quiet zone size is increased, enabling clear readings on the start and end regions of the barcode.
2. Barcodes with faded bars on transparent or translucent backgrounds are especially hard to tread. Fading might occur when the barcode is bleached or wears with age. For example, microarray slides are often barcoded at the start of their processing. The slide is passed through processes where the slide is washed and comes in contact with solvent solutions. The invention increases the contrast ratio between bars and intermediary spaces, making these barcodes easier to read.

By enabling the reading of transparent and translucent barcodes, the invention allows these styles of barcodes to be placed on either the front or the back surface of the slide. Prior to the present invention the barcode reader was required to have a fixed orientation relative to the slide, namely that it be positioned facing the front side of the glass. Physical space availability or accessibility restrictions might make this requirement difficult to implement in some processes. No such restrictions are needed when transparent or translucent barcodes are read by the barcode reading apparatus of the present invention.

What is claimed is:

1. A barcode reading apparatus for reading a translucent barcode strip on a major surface of a transparent slide, said barcode reading apparatus comprising:
a transmitter for projecting an incident light beam toward said barcode strip;
a light returning surface facing said transmitter and oriented to return a portion of said incident light beam transmitted through said slide back through said slide toward said transmitter; and
a detector oriented to receive portions of said incident light beam returned by said barcode strip and said light returning surface.

2. The barcode reading apparatus as recited in claim 1, wherein said detector is adjacent to said transmitter.

3. The barcode reading apparatus as recited in claim 2, wherein said transmitter and said detector are located in a single transceiver unit.

4. The barcode reading apparatus as recited in claim 1, wherein said transmitter, said light returning surface and said detector are positioned so that the incident light returned by said barcode strip and the incident light returned by said light returning surface are now parallel to said incident light beam.

5. The barcode reading apparatus as recited in claim 1, wherein said apparatus includes a light returning device which comprises:
(a) a planar base wall having said light returning surface;
(b) an end wall extending at an angle from said base wall at one end of said base wall; and
(c) an interior wall parallel to said end wall and spaced therefrom.

6. The barcode reading apparatus as recited in claim 5, wherein said light returning device comprises three strips fixed together, each of said strips having a U-shaped cross section comprising a base portion and a pair of spaced leg portions extending from said base portion.

7. The barcode reading apparatus as recited in claim 7, wherein the base portion of two of said strips abut longitudinally and lie on the same plane to form said planar base and said end wall and the third of said strips forms said interior wall.

8. A scanning mechanism for scanning a translucent barcode on a major surface of a transparent slide, comprising:
(a) a barcode reading station;
(b) a carousel having radial slots for removably holding a plurality of said slides, said carousel being rotatable to selectively position one of said slides adjacent said barcode reading station for enabling said selectively positioned slide to be removed from said carousel and moved to said barcode reading station;
(c) a transmitter for projecting an incident light beam toward said barcode strip at said barcode reading station;
(d) a light returning surface facing said transmitter for returning a portion of said incident light beam back through said slide toward said transmitter; and
(e) a detector oriented to receive portions of said incident light beam returned by said barcode strip and said light returning surface for reading said barcode.

9. The scanning mechanism as recited in claim 8, wherein said detector is adjacent said transmitter.

10. The scanning mechanism as recited in claim 9, wherein said transmitter and said detector are located in a single transceiver unit.

11. The scanning mechanism as recited in claim 8, wherein said light returning surface is white.

12. The scanning mechanism as recited in claim 9, wherein said transmitter, said light returning surface, and said detector are positioned so that the light returned from said barcode and the light returned from said light returning surface are at an angle to said incident light beam.

13. The scanning mechanism as recited in claim 8, further comprising a tray that has an annular vertical wall and an access opening in said vertical wall adjacent said slide identification station and, wherein said carousel is located within said annular wall and mounted for rotation on said tray and, wherein said light returning surface is mounted to said annular wall at said access opening.

14. The scanning mechanism as recited in claim 8, wherein the mechanism includes a light returning device comprising:
(a) a planar base wall having said light returning surface;
(b) at least one end wall extending at an angle from said base wall at one end of said base wall; and
(c) an interior wall spaced from said end wall to define a slot with said end wall for enabling said light returning device to be inserted on the free end of a supporting structure.

15. The scanning mechanism as recited in claim 14, wherein said light returning device is fabricated from three strips fixed together each of said strips having a U-shaped cross-section comprising a base portion and a pair of spaced leg portions extending from said base portion.

16. The scanning mechanism as recited in claim 15, wherein the base portion of two of said strips abut longitudinally and lie on the same plane to form said planar base and said end wall and the third of said strips forms said interior wall.

17. A method of reading a barcode strip on a major surface of a transparent slide, said method comprising:
(a) projecting an incident light beam toward the barcode strip;
(b) returning a first portion of said incident light beam at said barcode strip;
(c) passing a second portion of said incident light beam through said barcode strip;
(d) returning the second portion of said incident light beam back through said slide; and
(e) detecting the first and second portions of said incident light beam.

18. The method as recited in claim 17, wherein the light returned from said barcode strip and the light returned from said light returning device are at an angle to said incident light beam.
